(19) United States
(12) Patent Application Publication
(10) Pub. No.: US 2008/0131349 A1
(43) Pub. Date: Jun. 5, 2008

(54) High Efficiency Nitrogen Fertilizer and Process for its Manufacture

(75) Inventors: Peng Zhang, Horseheads, NY (US); Bin Wen, Horseheads, NY (US)

Correspondence Address: Peng Zhang, 111 Ridge Road, Horseheads, NY, 14845, US

(73) Assignee: United Environment & Energy LLC, Horseheads, NY (US)

(21) Appl. No.: 11/949,042

(22) Filed: Dec. 2, 2007

Related U.S. Application Data
(60) Provisional application No. 60/868,351, filed on Dec. 3, 2006.

(51) Int. Cl. C01B 33/26

(52) U.S. Cl. 423/327.1

(57) ABSTRACT

The present invention provides a slow release nitrogen fertilizer and a process for manufacturing the fertilizer, wherein the fly ash from coal-fired power plants that may contain high concentration of mercury and carbon is used as the main feedstock and the carbonitridation reaction is used to convert fly ash to silicon aluminum oxynitride in the presence of nitrogen gas and carbon. Silicon aluminum oxynitride is subsequently used as a slow release nitrogen fertilizer. The mercury contained in the fly ash is recovered before carbonitridation reaction takes place.

This application claims the benefit of the provisional application, 60/868,351, filed on Dec. 3, 2006.

### DESCRIPTION

1. Field of the Invention

The present invention relates to a slow release nitrogen fertilizer—silicon aluminum oxynitride (SiAlON) and process for manufacturing this nitrogen fertilizer from coal-fired power plant fly ash that may contain high concentration carbon and mercury.

2. Background of the Invention

Nitrogen fertilizer is the primary fertilizer applied to farm fields during the various stages of crop growth. Traditional nitrogen fertilizers are water-soluble compounds made from ammonia, which is synthesized from hydrogen and nitrogen by the century-old Haber-Bosch process. 30-70% of these fertilizers are easily washed away by rains or irrigation water, resulting in significant loss of fertilizer and pollution of streams and ground water (U.S. P:at. No. 4,994,100 to Sutton). There have been many efforts toward the development of a high-efficiency nitrogen fertilizer which would release nitrogen slowly such that the nitrogen would remain in the soil and be available to the crops for a longer period of time. Some attempts to improve the efficiency of traditional nitrogen fertilizers include the use of polymer coatings or other coating methods to protect the nitrogen fertilizer from water.

Urea-formaldehyde, oxamide, melamine, and other compounds have been investigated as high efficiency nitrogen fertilizers. However, this kind of fertilizer is much more expensive than the usual fertilizers. Coating technology has also been used to decrease the release rate of traditional nitrogen fertilizers. The patent assigned to Dhar et al. (U.S. P:at. No. 6,336,949 to Dhar) disclosed that urea was coated with essential oils and their derivatives. U.S. P:at. No. 6,315,807 B141 to Dhar claimed urease inhibitors that were used to retard the hydrolysis of urea and minimize ammonia losses. EXXON Research Engineering CO disclosed coating vegetation enhancement agents, such as fertilizers (urea) and fertilizer-pesticide combinations, with thin or ultra thin coatings of sulfonated polymers (U.S. P:at. No. 5,435,821 to ILAN). However, coating is not commercially popular among large-scale consumers because of the high cost and adverse effects on soil.

Until now, no existing slow-release fertilizers could replace the water soluble fertilizers on a large scale because of the high cost and adverse effects of coating on soil. Only a simple production process and inexpensive materials may be used for production of a successful slow-release fertilizer.

Silicon aluminum oxynitride (SiAlON) powders are water insoluble. When in contact with water, however, the SiAlON-based powders slowly hydrolyze to silicates, aluminates, and ammonia. The slow hydrolysis of SiAlON to produce ammonia makes it as a slow release high efficiency nitrogen fertilizer, which has long been in demand.

SiAlON is synthesized using silica and alumina as raw materials and carbon as a reducing agent in a nitrogen atmosphere at high temperatures through the carbonitridation reaction:

(12-2m)SiO₂+mAl₂O₃+(24-3m)C+(8-m)N₂→2Si₆₋ₘAlₘOₘN₈₋ₘ+(24-3m)CO (1)

### To produce low cost SiAlON, high volume and inexpensive raw materials containing silicon and aluminum elements should be used.

Fly ash is considered to be the world's fifth-largest mineral resource. Silica (SiO₂: 30.9-62.8 wt. %) and alumina (Al₂O₃: 12.3-27.0 wt. %) are the two main oxide materials contained in fly ash, which can be used for SiAlON synthesis. America's coal-fired power plants produce more than 76.5 million tons of fly ash per year. Approximately 67% of all fly ash produced is disposed of in landfills or surface impoundments. The remaining 33% is used for a variety of commercial applications, primarily as cementitious material for concrete products and as feedstock for Portland cement manufacture.

On Mar. 15, 2005, the Environmental Protection Agency (EPA) issued the first-ever federal rule to permanently cap and reduce mercury emissions from coal-fired power plants. These regulations are directed at the existing fleet of nearly 1,100 boilers. Activated carbon injection (ACI) is the most effective and widely used technology for capturing mercury from flue gas and also represents one of the simplest and most mature approaches to controlling mercury emissions for power plants. However, ACI results in fly ash that contains a certain amount of mercury-containing activated carbon. The presence of activated carbon significantly increases the carbon content of the ash and may eliminate concrete as a viable market for the reuse of fly ash. Furthermore, the mercury adsorbed by the activated carbon poses a risk for the release of mercury into the environment, making the disposal of fly ash more difficult and costly. This means that with the ACI process, the power plants would not only lose revenues from fly ash sales, they would incur additional expenses for landfill disposal of the mercury-contaminated high carbon fly ash. Therefore, any beneficial, practical application of such mercury-contaminated high carbon fly ash would be economically and environmentally advantageous compared to the costly disposal practice and would greatly relieve the pressure on the power industry.

The main objective of the present invention is to convert fly ash to silicon aluminum oxynitride (SiAlON) and to use SiAlON as a slow release nitrogen fertilizer.

Another objective of the present invention is to recover the mercury that may contain in the fly ash.

Still another objective of the present invention is to use fly ash from different power plants that may have different compositions for SiAlON production.

### SUMMARY OF THE INVENTION

The present invention relates to a slow release nitrogen fertilizer and a process for manufacturing this fertilizer. Fly ash from coal-fired power plants that may contain high concentration of mercury and carbon is used as the main feedstock. The carbonitridation reaction is used to convert fly ash to silicon aluminum oxynitride in the presence of nitrogen gas and carbon. Silicon aluminum oxynitride is subsequently used as a slow release nitrogen fertilizer. The mercury contained in the fly ash is recovered before carbonitridation reaction takes place.

### BRIEF DESCRIPTION OF THE DRAWING

FIG. 1 is a schematic illustration of the nitrogen fertilizer production and mercury recover process.

### DETAILED DESCRIPTION OF THE INVENTION

As used herein and in the appended claims, the singular forms “a”, “an”, and “the” include plural references unless the content clearly dictates otherwise. Thus, for example, reference to “a material” includes a plurality of such material and equivalents thereof known to those skilled in the art. All publications, p:atent applications, p:atents, and other references mentioned herein are incorporated by reference in their entirety.

The present invention generally provides a high efficiency slow release nitrogen fertilizer silicon aluminum oxynitride and a manufacturing process for this fertilizer production from fly ash.

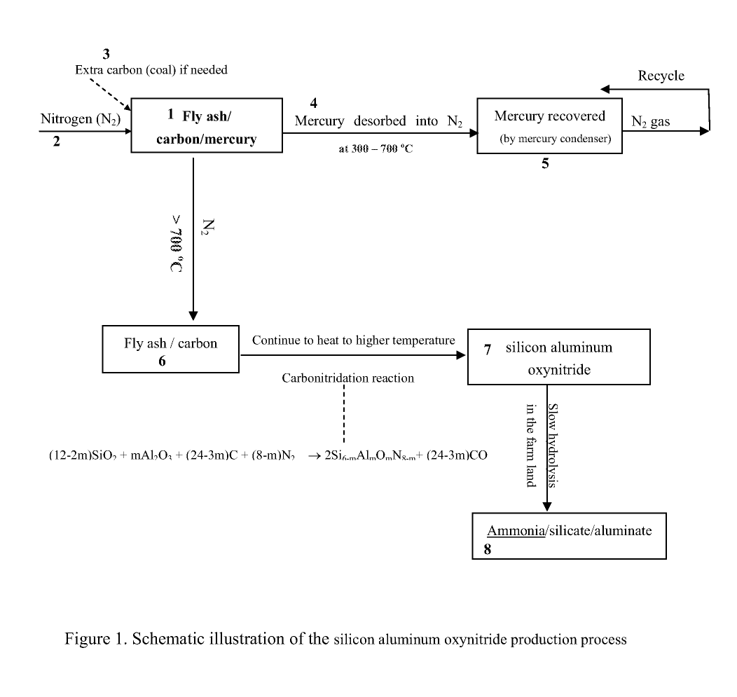

A manufacturing process provided according to the present invention is schematically illustrated in FIG. 1 of the drawing. The flay ash 1 containing mercury and carbon is loaded into a kiln. The mercury 4 contained in the fly ash is liberated from the fly ash/carbon into the nitrogen flow 2 when the temperature reaches about 300° C. The nitrogen gas passes through a mercury condenser 5, and the mercury 4 contained in the gas is recovered. All of the mercury contained in the fly ash/carbon will desorb before the temperature reaches 700° C. Continuing to heat the mixture in nitrogen will initiate the carbonitridation reaction, and the fly ash will be converted to SiAlON fertilizer 7. The SiAlON can be produced directly at coal power plants with proper equipment modification and installation. This on-site technology would avoid the cost of transporting fly ash to processing plants. Raw materials, such as nitrogen, fly ash, and carbon are readily available at coal power plants at a very low cost (if the carbon content in the fly ash is not high enough, power plant coal can be added for the reaction). The heat needed for the carbonitridation reaction can be obtained partially from plant waste heat recovery, and the rest can be obtained from combustion of coal. The nitrogen content in this fertilizer is up to 25 wt %, close to the nitrogen content of ammonia-based industrial fertilizers.

The temperature required to initiate the carbonitridation reaction is preferably lower than 1300° C., and more preferably lower than 1200° C. The reaction time is preferably less than 2 hours, and more preferably less than 1 hour. The carbon content in the fly ash is preferably lower than 35 weight percent, and more preferably lower than 30 weight percent.

Cleaned flue gas from the power plants can be utilized as a source of nitrogen gas. The commercial gas separation process can easily separate all the other gases from nitrogen.

The SiAlON nitrogen fertilizer also contains all other trace elements necessary for plant growth (micronutrients like Fe, Zn, Cu, and Mo and macro nutrients like K, P, and Ca). These trace elements are from fly ash.

The invention is further described by the following examples, which are set forth to aid in the understanding of the invention, and should not be construed to limit in any way the scope of the invention.

### EXAMPLE 1

40 g power plant fly ash that contains 23 weight percent carbon was loaded into an pure alumina crucible. The crucible was loaded into a high temperature furnace. A nitrogen flow gas at a flow rate of 1 L/min was introduced into the crucible. After purging for one hour, the temperature of the furnace was increased from 25° C. to 1200° C. at a temperature ramp of 30° C./min. The temperature was kept at 1200° C. for one hour and then was decreased from 1200° C. to 100° C. at a temperature ramp of 30° C. The nitrogen content in the product was measured using Nitrogen/Oxygen Analyzer. The nitrogen content was 23 weight percent in the product.

What is claimed is:

1. A silicon aluminum oxynitride slow release nitrogen fertilizer and a process for manufacturing the fertilizer, wherein the fly ash from coal-fired power plants or other sources that may contain high concentration of mercury and carbon is used as the main feedstock and the carbonitridation reaction is used to convert fly ash to silicon aluminum oxynitride in the presence of nitrogen gas and carbon.

2. The silicon aluminum oxynitride of claim 1, wherein the silicon aluminum oxynitride is capable of slowly releasing nitrogen in the form of ammonia when it contacts with water.

3. The silicon aluminum oxynitride of claim 1, wherein its composition may vary over a wide range that allows for the potential to use fly ash from different coal plants with different compositions.

4. The fly ash of claim 1, wherein the fly ash may contain high concentrations of mercury and carbon.

5. The mercury of claim 4, wherein the mercury desorbs from the fly ash and carbon to nitrogen gas in a certain temperature range and is subsequently recovered by a mercury condenser.

6. The carbon of claim 1, wherein the residual carbon left in the fly ash that is well mixed with fly ash is used as the reducing agent for the carbonitridation reaction. Coal and other carbon sources are added for the reaction if more carbon is required.

7. The carbonitridation reaction of claim 1, wherein the reaction temperature is preferably lower than 1300° C., and more preferably lower than 1200° C.

8. The carbonitridation reaction of claim 1, wherein the reaction time is preferably less than 2 hours, and more preferably less than 1 hour.

9. The carbonitridation reaction of claim 1, wherein the carbon content in the fly ash is preferably lower than 35 weight percent, and more preferably lower than 30 weight percent.
